(19) United States
(12) Patent Application Publication
(10) Pub. No.: US 2025/0010395 A1
(43) Pub. Date: Jan. 9, 2025

(54) METHOD FOR PRODUCING HIGH-QUALITY ULTRASONICALLY WELDED SPOT JOINTS

(71) Applicant: UT-Battelle, LLC, Oak Ridge, TN (US)

(72) Inventors: Jian Chen, Oak Ridge, TN (US); Zhili Feng, Oak Ridge, TN (US); Hui Huang, Oak Ridge, TN (US); Yong Chae Lim, Oak Ridge, TN (US)

(21) Appl. No.: 18/761,546

(22) Filed: Jul. 2, 2024

Related U.S. Application Data
(60) Provisional application No. 63/525,379, filed on Jul. 7, 2023.

(51) Int. Cl. B23K 20/10; B23K 31/00

(52) U.S. Cl. CPC B23K 20/106; B23K 31/00

(57) ABSTRACT

An improved method for friction pressure welding via indentation-depth control is provided. The method includes: (a) bringing a sonotrode into contact with an upper workpiece with a clamping force; (b) recording the sonotrode position as a reference when in contact with the upper workpiece; (c) applying an electrical current to a transducer to generate high-frequency vibrations and frictional heat at a faying joint interface; (d) measuring a downward displacement of the sonotrode as the weld area softens and the surface indentation increases; and (e) terminating the electrical current to the transducer and retracting the sonotrode from the upper workpiece in response to a predetermined downward displacement of the sonotrode (indentation depth). The method of the present invention can achieve quality joints independent of joint locations, part geometry, or fixture conditions.

### CROSS-REFERENCE TO RELATED APPLICATIONS

This application claims the benefit of U.S. Provisional Application 63/525,379, filed Jul. 7, 2023, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to ultrasonic welding processes for joining materials through the application of high-frequency acoustic vibrations.

### BACKGROUND OF THE INVENTION

Lightweight materials such as high-strength aluminum alloys and magnesium alloys are being increasingly used in many manufacturing fields, particularly in the automotive industry, to reduce fuel consumption and greenhouse gas emissions. However, joining aluminum or magnesium alloys with conventional fusion welding techniques such as spot resistance welding is problematic. For example, spot resistance welding can result in defects such as hot cracking and porosity from non-equilibrium solidification and segregation of impurity elements.

Ultrasonic spot welding is a solid-state process that produces weld joints by localized high-frequency tangential vibration under moderate clamping pressure. The welding cycle is typically short, on the order of one second or less. FIG. 1 depicts a conventional ultrasonic welding apparatus. In operation, a transducer 10 generates a high-frequency lateral vibration, typically between 15 kHz and 40 kHz, and delivers energy through a sonotrode 12 to the upper workpiece 14. The temperature at the interface between the upper workpiece 14 and the lower workpiece 16 increases due to interfacial friction, plastic deformation, and elastic hysteresis, but this increase is generally not sufficient to melt the upper and lower workpieces. Instead, the high temperature and pressure at the joint interface induces rapid atomic level diffusion across the interface of the two metal workpieces to form the joint with superior mechanical strength.

Because of the distinct characteristics of ultrasonic spot welding, this process has been used in many sectors including automotive, electronics, packaging, and medical. Attempts have been made to ensure weld quality by monitoring various in-process parameters such as power, energy, and temperature. However, ultrasonic spot welding processes remain limited in joining relatively small metal components such as battery tabs and electric wires. Due to the vibration-induced wave propagation and structural interaction, it is not feasible to use one set of processing parameters (typically a predetermined welding energy) to consistently obtain high-quality weld joints at various locations throughout a larger structure. It is also not feasible to apply the same set of welding parameters (e.g., constant welding energy) to weld other metal structures that have different geometries or fixture/boundary conditions even if the material stack-ups are the same. In other words, ultrasonic spot welding process parameters are not only material dependent, but also structural geometry dependent. For example, FIG. 2A depicts a magnesium-steel sample that consists of five ultrasonic spot welded joints to represent a large-scale structure. All joints in the sample were welded using the same set of processing parameters. As shown in FIG. 2B however, the welds exhibited were joint strength (peak lap shear strength) that varied from 0.5 kN to over 4 kN.

Accordingly, there remains a continued need for an improved ultrasonic spot welding process for joining two or more workpieces. In particular, there remains a continued need for an improved ultrasonic spot welding process for joining similar or dissimilar materials to overcome the drawbacks of conventional methods while achieving consistent weld joints.

### SUMMARY OF THE INVENTION

An improved method for ultrasonic spot welding via indentation-depth control is provided. The method includes: (a) bringing a sonotrode into contact with an upper workpiece with a clamping force; (b) recording the sonotrode position as a reference when in contact with the upper workpiece; (c) applying an electrical current to a transducer to generate high-frequency vibrations and frictional heat at a faying joint interface between the upper workpiece and a lower workpiece; (d) measuring a downward displacement of the sonotrode as the weld area softens and the surface indentation increases; and (e) terminating the electrical current to the transducer and/or retracting the sonotrode from the upper workpiece in response to a predetermined downward displacement of the sonotrode. As explained herein, the method of the present invention was found to consistently obtain quality joints independent of joint locations or part geometry.

In another embodiment, a control system for an ultrasonic spot welding apparatus is provided. The control system includes a position sensor for measuring the downward displacement of a sonotrode relative to an anvil. A controller monitors the output of the position sensor according to an open-loop control function. For example, the controller continuously compares the downward displacement of the sonotrode with a setpoint value. The set-point value is user-selectable, optionally as a percentage of the total thickness of a multi-layer workpiece stack. For example, the set-point value can be between 0.5% and 30% of the total thickness of the workpiece stack. In some embodiments, the set-point value is between 0.2 mm and 2.0 mm, however the set-point value can be outside of this range in other embodiments. Once the downward displacement of the sonotrode meets or exceeds the setpoint value, the controller terminates the electrical current to the transducer and/or retracts the sonotrode from the upper workpiece of a workpiece stack. At the conclusion of each weld, the workpiece stack and/or the ultrasonic spot welding apparatus is repositioned for the next ultrasonic weld joint to achieve a strong lap joint having a superior lap shear strength when compared to conventional systems and methods.

These and other features of the invention will be more fully understood and appreciated by reference to the description of the embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a schematic representation of a prior art apparatus for ultrasonic spot welding.

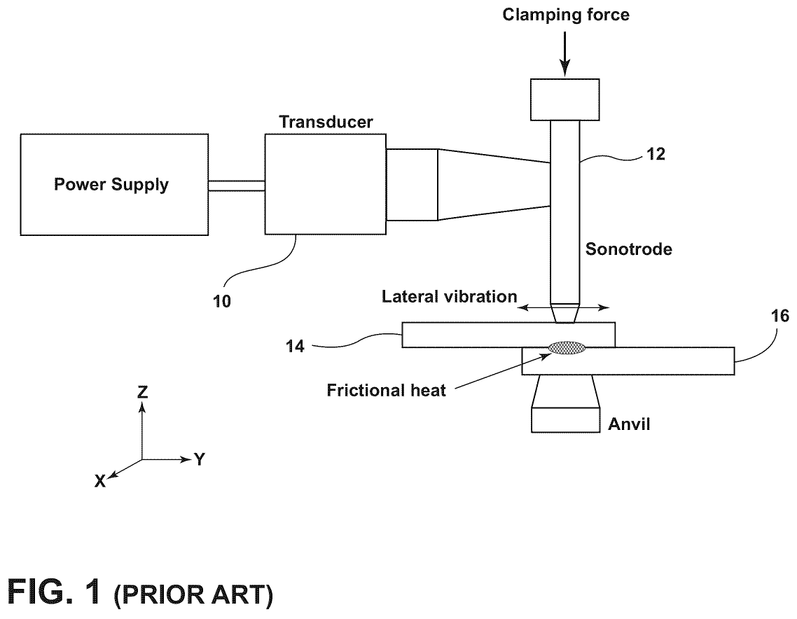

FIG. 2A is an image of a multi-joint ultrasonic spot welding sample according to the prior art, and FIG. 2B is a graph depicting peak lap shear strength of each individual joint.

FIG. 3 is a graph depicting a relationship between the surface indentation depth and the peak lamp shear strength for multiple ultrasonic spot welds.

FIG. 4 is a schematic representation of an apparatus for ultrasonic spot welding according to an embodiment of the present invention.

FIG. 5A is an image of a multi-joint ultrasonic spot welding sample according to the present invention, and FIG. 5B is a graph depicting peak lap shear strength of each individual joint.

### DETAILED DESCRIPTION OF THE CURRENT EMBODIMENT

As discussed herein, the current embodiment relates to an improved method for ultrasonic spot welding. The method generally includes: (a) bringing a sonotrode into contact with an upper workpiece with a predetermined clamping force; (b) recording the sonotrode position as a reference when in contact with the upper workpiece (zero surface indentation); (c) applying an electrical current to a transducer to generate high-frequency vibrations and frictional heat at a faying joint interface between the upper workpiece and a lower workpiece; (d) measuring a downward displacement of the sonotrode as the weld area softens and the surface indentation increases; and (e) terminating the electrical current to the transducer and retracting the sonotrode from the upper workpiece in response to a predetermined downward displacement of the sonotrode (indentation depth). With this methodology, ultrasonic spot welds with consistent indentation depths can be achieved. The method of the present invention was found to consistently obtain quality joints independent of joint locations, part geometry, or fixture conditions.

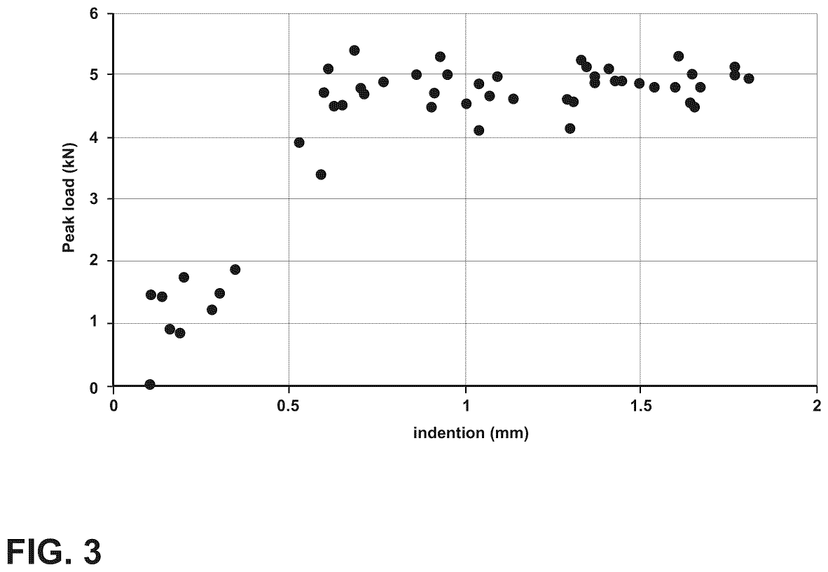

Before each step is discussed in detail, the relationship between indentation depth and weld strength will be discussed. For a given material stack-up, the inventors discovered a relationship between the surface indentation and the peak lap shear failure load (FIG. 3). As used herein, the “lap shear failure load” is the maximum load that a lap joint can withstand before failing when subject to a shear force. In any lap joint, two overlapping pieces of material are bonded together, and the shear force acts parallel to the plane of the joint. When the surface indentation was in the range of 0.0 mm to 0.6 mm, the peak load linearly increased with indentation depth. Hence, a desired peak load can be expected when the indentation depth reaches an appropriate threshold or range. For indentation above 0.6 mm, the peak load was found to remain generally constant (between 4 kN and 6 kN), up to an indentation depth of 2 mm in laboratory testing.

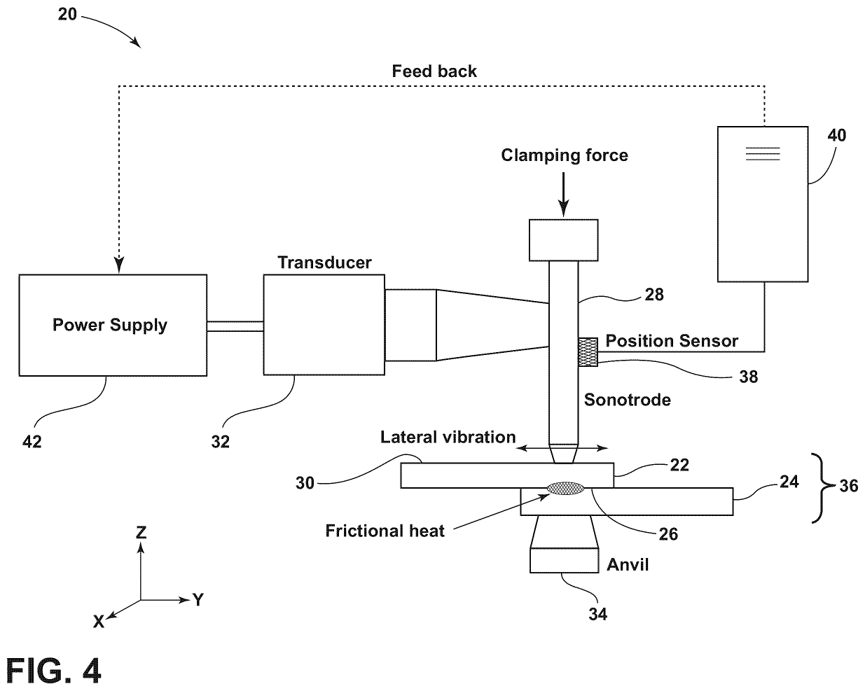

Each such method step will now be described, with the aid of FIG. 4. The material stack-up generally includes a first workpiece 22 and a second workpiece 24 (comprising a workpiece stack 36) that are in contact with each other along a faying joint interface 26. As used herein, the terms “workpiece stack” and “material stack-up” include two or more (e.g., two, three, four, or more) workpieces. For example, while the material stack-up 36 of FIG. 4 includes only two workpieces 22, 24, in other embodiments the material stack-up 36 includes three or more workpieces. The sonotrode 28 is brought into contact with an upper surface 30 of the first workpiece 22, typically by lowering the tip of the sonotrode 28 vertically, orthogonal to the plane of the joint interface 26. Also referred to as a horn, the sonotrode 28 functions by transmitting ultrasonic energy from a transducer 32 to a small, specific area of the first workpiece 22, creating intense localized frictional heat. The sonotrode 28 is opposite of an anvil 34, and a downward clamping force on the sonotrode 28 ensures continuous contact with the stack 36 during welding operations. The present invention is not limited to any one particular sonotrode, and the sonotrode can be manufactured from titanium, aluminum, or hardened steel, by example. The clamping force is generally constant, optionally between 100 and 1000 N for metal components and 50 to 200 N for plastic components. The clamping force can vary in other embodiments.

The method then includes recording the sonotrode position (Z-direction) as a reference when brought into contact with the upper surface 30 of the first workpiece 22, i.e., zero surface indentation. To accomplish this step, a position sensor 38 is used to measure the vertical displacement of the sonotrode 28. The present invention is not limited to any one particular position sensor. Suitable position sensors can include, for example, a linear variable differential transformer (inductive sensing), an optical encoder (optical sensing), a capacitive sensor (capacitive sensing), or a laser displacement sensor (optical sensing). Other position sensors can be used in other embodiments. The position sensor 38 is fixed in relation to the workpiece stack 36, such that relative vertical motion exists between the position sensor 38 and the sonotrode 28. In other embodiments, the position sensor 38 is fixed in relation to the sonotrode 28 and measures a vertical displacement relative to the first workpiece 22, optionally via a laser range finder. In another embodiment, the position sensor 38 is fixed in relation to the anvil 34 and measures a vertical displacement relative to the sonotrode 28.

The output of the position sensor 38 is transmitted to a central controller 40 for controlling the position of the sonotrode 28 and the clamping force of the sonotrode 28. The central controller 40 performs a variety of additional functions, including regulating the power delivered by the power supply 42 and regulating the frequency output of the transducer 32. The central controller 40 includes an optional user interface, which can provide an interface for operators to set parameters, start and stop the welding process, and view real-time data and diagnostics. The central controller 40 can also save processing parameters, ensuring repeatability and efficiency, and the central controller 40 can alert weld operators to any issues or anomalies during the welding process, such as power fluctuations or frequency deviations.

Once the sonotrode 28 is in contact with the first workpiece 22 (without indenting the first workpiece 22), the method then includes applying an electrical current to the transducer 32. This step includes converting a mains voltage into a high-frequency electrical current, typically on the order of 15 kHz to 40 kHz. The power supply 42 provides the suitable electrical current to the transducer 32, which converts electrical energy into mechanical vibrations, primarily in the X and Y directions (i.e., parallel to the plane of the joint interface 26). The present invention is not limited to any particular transducer. Suitable transducers can include, for example, piezoelectric crystals or ceramics that undergo rapid expansion and contraction when applied with a high-frequency electrical current. The resulting mechanical vibrations comprise high-frequency sound waves, which are inaudible to the human ear. These mechanical vibrations are transferred to the sonotrode 28, which remains in physical contact with the transducer 32. Throughout this process, the clamping force imposed on the sonotrode 28 remains constant, but the clamping force can vary in other embodiments. The sonotrode 28 focuses and amplifies the mechanical vibrations to the weld spot. In addition, the sonotrode 28 can be tuned to resonate at the same frequency as the transducer 32 to maximize the efficiency of the energy transfer to the weld spot.

As the vibrations are applied to the stack and the weld area softens, the position sensor 38 measures the downward displacement of the sonotrode 28. The vibrations create localized heat for joining the first and second workpieces 22, 24 along the faying joint interface 26. The high temperature and pressure at the weld spot induces rapid atomic level diffusion across the faying joint interface 26. Throughout this process, which can occur on the order 0.2 to 1.0 seconds for plastic materials and 0.2 to 1.5 seconds for metal materials, the controller 40 monitors the output of the position sensor 38 according to an open-loop control function. In particular, the controller 40 continuously compares the downward displacement of the sonotrode 28 (due to softening at the weld area) with a setpoint value, for example 1.0 mm. Other setpoint values can be used in other embodiments, including a setpoint value between 0.5 mm and 2 mm, inclusive. The precise setpoint value can vary depending on the composition of the workpiece stack and the thickness of the first and second workpieces. Once the downward displacement of the sonotrode 28 meets or exceeds the setpoint, the controller 40 terminates the electrical current to the transducer 32 and/or retracts the sonotrode 28 from the upper workpiece 22. For example, the controller 40 can terminate power to the transducer 32, can raise the sonotrode 28 (or lower the anvil 34), or terminate power and raise the sonotrode. At the conclusion of each weld, the workpiece stack 36 and/or the weld apparatus 20 is repositioned for the next ultrasonic weld joint to achieve a strong lap joint.

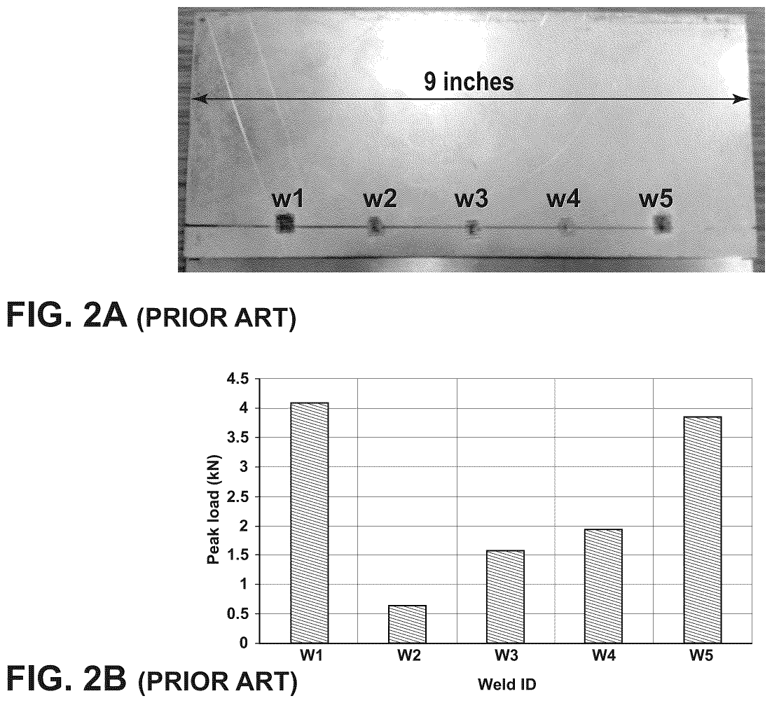

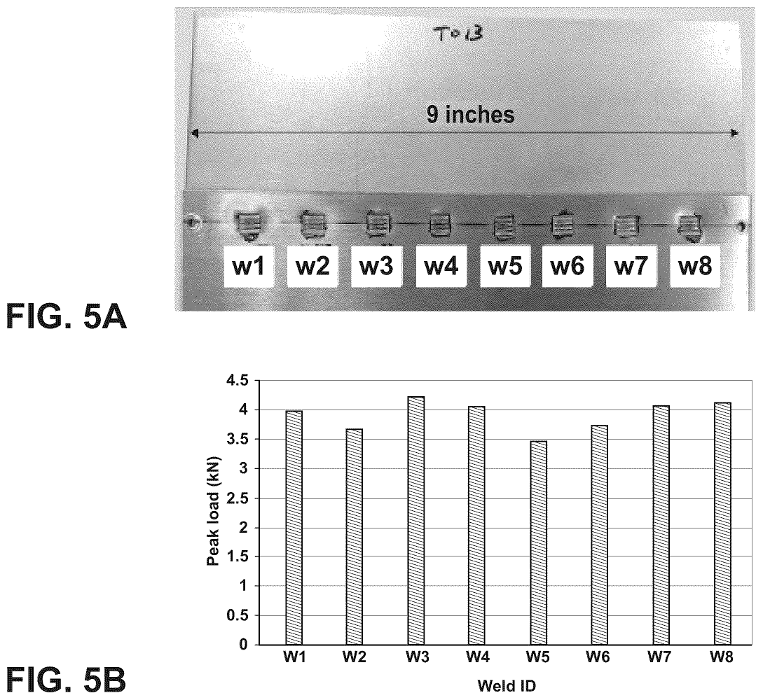

To reiterate, the ultrasonic weld apparatus 20 generally includes a power supply 42, a transducer 32, a sonotrode 28, a position sensor 38, a controller 40, and an anvil 34 for creating one or more ultrasonic spot welds in a material stack. The position sensor 38 monitors the relative distance between the sonotrode 28 and the anvil 34. The ultrasonic weld apparatus 20 makes possible an improved method of ultrasonic spot welding via indentation-depth control. The improved method achieves quality joints independent of joint locations, part geometry, or fixture conditions. As shown in FIGS. 5A-5B for example, the present method consistently formed high quality joints in a magnesium-steel sample via indentation-depth control. By ensuring each indentation is at least a minimum predetermined depth, the peak lap shear strength was consistently between 3.0 kN and 4.5 kN, which is a marked improvement over sample of FIG. 2B, in which the peak lap shear strength varied widely between 0.5 kN and 4.0 kN.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method comprising:
applying a clamping force to a sonotrode to bring the sonotrode into contact with an upper surface of a first workpiece of a workpiece stack, the first workpiece being in direct or indirect contact with a second workpiece along a faying joint interface;
applying power to a transducer of an ultrasonic spot welding apparatus, the transducer being physically coupled to the sonotrode, the sonotrode being opposite of an anvil, such that the first and second workpieces are disposed between the sonotrode and the anvil;
measuring, using a position sensor, a displacement of the sonotrode relative to an initial position of the sonotrode in which the sonotrode does not penetrate the first workpiece; and
in response to the displacement of the sonotrode exceeding a predetermined setpoint value, terminating the application of power to the ultrasonic transducer or retracting the sonotrode from the workpiece stack to create a spot weld joint at the faying joint interface.

2. The method of claim 1, wherein the spot weld joint is a solid-state weld joint, such that a melting temperature of the first workpiece and the second workpiece is not exceeded.

3. The method of claim 1, wherein the position sensor is configured to measure a vertical displacement of the sonotrode relative to the anvil.

4. The method of claim 1, wherein the predetermined setpoint value is user-selectable and varies between 0.5% and 30% of a thickness of the workpiece stack.

5. The method of claim 1, wherein the predetermined setpoint value is at least 0.2 mm.

6. The method of claim 1, wherein the transducer is configured to induce vibrations in the sonotrode in a plane that is parallel to the faying joint interface.

7. The method of claim 6, wherein the position sensor is configured to measure the displacement of the sonotrode in a direction orthogonal to the faying joint interface.

8. The method of claim 1, wherein the first workpiece comprises a first material and wherein the second workpiece comprises a second material, the first material being different than the second material.

9. The method of claim 1, wherein the first workpiece comprises a first material and wherein the second workpiece comprises a second material, the first material being identical to the second material.

10. The method of claim 1, wherein the first workpiece and the second workpiece include aluminum, magnesium, titanium, steel, or alloys thereof.

11. A control system for an ultrasonic welding apparatus comprising:
a power supply connected to an ultrasonic transducer;
a sonotrode in physical contact with the ultrasonic transducer;
an anvil positioned opposite of the sonotrode, such that a workpiece stack can be disposed between the sonotrode and the anvil;
a position sensor configured to measure the position of the sonotrode during the application of ultrasonic vibrations to the sonotrode; and
a controller coupled to the output of the position sensor, the controller being configured to measure, based on the output of the position sensor, a displacement of the sonotrode relative to an initial position of the sonotrode in which the sonotrode contacts but does not penetrate an upper workpiece of the workpiece stack and, in response to the displacement of the sonotrode exceeding a predetermined setpoint value, terminate the application of ultrasonic energy to the sonotrode to create a spot weld joint at a faying joint interface within the workpiece stack.

12. The control system of claim 11, wherein the position sensor is configured to measure a vertical displacement of the sonotrode relative to the anvil.

13. The control system of claim 11, wherein the predetermined setpoint value is user-selectable and varies between 0.5% and 30% of a thickness of the workpiece stack.

14. The control system of claim 11, wherein the predetermined setpoint value is at least 0.2 mm.

15. The control system of claim 11, wherein the transducer is configured to induce vibrations in the sonotrode in a plane that is parallel to the faying joint interface.

16. The control system of claim 15, wherein the position sensor is configured to measure the displacement of the sonotrode in a direction orthogonal to the faying joint interface.

17. The control system of claim 11, wherein the measured displacement of the sonotrode corresponds to a depth of an indentation in the upper workpiece of the workpiece stack.

18. The control system of claim 11, wherein:
the workpiece stack includes a first workpiece and a second workpiece; and
the first workpiece comprises a first material and the second workpiece comprises a second material, the first material being different than the second material.

19. The control system of claim 11, wherein:
the workpiece stack includes a first workpiece and a second workpiece; and
the first workpiece comprises a first material and the second workpiece comprises a second material, the first material being the same as the second material.

20. The control system of claim 11, wherein the first workpiece and the second workpiece include aluminum, magnesium, titanium, steel, or alloys thereof.
